(19) United States
(12) Patent Application Publication
(10) Pub. No.: US 2019/0123325 A1
(43) Pub. Date: Apr. 25, 2019

(54) SECONDARY BATTERY PREVENTING DENDRITE GROWTH

(71) Applicants: Hyundai Motor Company, Seoul (KR); Kia Motors Corporation, Seoul (KR)

(72) Inventors: Sang Mok Park, Gwangju (KR); Yoon Sung Lee, Suwon (KR); Seung Min Oh, Incheon (KR); Ki Seok Koh, Suwon (KR); Yeol Mae Yeo, Anseong (KR)

(21) Appl. No.: 15/848,742

(22) Filed: Dec. 20, 2017

(30) Foreign Application Priority Data
Oct. 25, 2017 (KR) 10-2017-0139579

(51) Int. Cl. H01M 2/16; H01M 10/42; H01M 10/052; H01M 10/0562; H01M 4/66

(52) U.S. Cl. CPC H01M 2/1686; H01M 10/42; H01M 10/052; H01M 10/0565; H01M 4/661; H01M 2200/00; H01M 2300/0071; H01M 10/0562

(57) ABSTRACT

The present invention provides a secondary battery that includes a metal ion receptor, which can absorb metal dendrites generated on the surface of a cathode while the battery is used, in a battery cell, whereby it is possible to improve safety by suppressing growth of dendrites and preventing a short due to a dendrite by making metal dendrites be absorbed in the metal ion receptor before the dendrites growing on the surface of the cathode reach the surface of an anode.

### CROSS-REFERENCE TO RELATED APPLICATION

This application claims under 35 U.S.C. § 119(a) the benefit of priority to Korean Patent Application No. 10-2017-0139579 filed on Oct. 25, 2017, the entire contents of which are incorporated herein by reference.

### TECHNICAL FIELD

The present invention relates to a secondary battery and a structure thereof that may be capable of preventing dendrite growth and preventing a short circuit due to the dendrite growth on the surface of an electrode.

### BACKGROUND

A secondary battery such as a lithium secondary battery stores electric energy in chemical energy and generates electricity.

The lithium secondary battery typically includes an anode, a cathode, and an electrolyte and a separator that provide a path of lithium ions moving between the anode and the cathode, thereby generating electric energy as oxidation and reduction occurs when the lithium ions are inserted into and separated from the two electrodes of the cathode and the anode.

Meanwhile, during the oxidation and reduction, electron density may be concentrated on rough surface of the anode, non-uniform needlelike dendrites can grow on the surface of the anode as lithium crystalline is formed after charging and discharging repeated several times.

When dendrites are generated during use of the secondary battery, the internal resistance of the battery is increased, so the charging/discharge efficiency is reduced. Further, in particular, when the dendrites keep growing and directly or indirectly come in contact with the surface of the cathode at the opposite side through the separator, a short circuit occurs in the battery.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention may provide a secondary battery that comprises a metal ion receptor, which may absorb metal dendrites generated on the surface of an anode while the battery is used, such that safety thereof may c improved by suppressing growth of dendrites. In addition, a short circuit due to a dendrite may be prevented by absorbing metal dendrites with the metal ion receptor by preventing the dendrites from contacting the surface of the cathode.

The term “secondary battery” as used herein refers to a battery that can be recharged or rechargeable for use during a life span by repeating charging and discharging. Exemplary secondary battery may include, but not be limited to, a lithium ion battery, a lithium-sulfur battery, a lead acid battery or the like.

In one aspect, provided is a secondary battery in which dendrite growth may be efficiently prevented. The secondary battery may include 1) a cathode; 2) an anode; 3) electrolytes comprising a first electrolyte and a second electrolyte and disposed between the cathode and the anode; 4) separators comprising a first separator and a second separator and disposed between the cathode and the anode; and 5) a metal ion receptor disposed between the cathode and the anode. Preferably, at least a first surface, which faces the anode, of the metal ion receptor may be contacted by the first separator. In particular aspect, the first surface of the metal ion receptor may be insulated by the first separator. For example, the first surface of the metal ion receptor may suitably be covered, coated or wrapped by the first separator.

The “insulated” as used herein is meant by being electrically insulated, such that electrons may not transfer or move through or on the insulated subject. Preferred insulation may be obtained by a material having high or substantially high resistance to electric current, such as polymers, glasses, silicon materials or the like.

In a preferred embodiment, when the first separator is separated from a surface of the anode, for example, by a first electrolyte disposed between the first separator, and the anode, a second surface, which faces to the cathode, of the metal ion receptor may be contacted by the second separator.

For instance, when the first electrolyte is disposed between a first surface of the first separator, which faces the anode, and a surface of the anode, the metal ion receptor may be contacted by the second separator on a second surface that faces to the cathode. In particular aspect, the second surface of the metal ion receptor may be insulated by the second separator. For example, the second surface of the metal ion receptor may suitably be covered, coated or wrapped by the second separator.

In another preferred embodiment, when the first separator is contacted by the surface of the anode, the second separator between the cathode and the metal ion receptor may be separated from, or otherwise, not contacted by the second surface of the metal ion receptor. The second surface of the metal ion receptor may not be contacted by the second separator.

Preferably, when a metal dendrite growing from a surface of the anode is electrically connected with the metal ion receptor through the first separator on the first surface of the metal ion receptor, the metal dendrite may be absorbed and received in the metal ion receptor. Preferably, an electric potential of the metal ion receptor when the metal ions are not received yet in the metal ions receptor from the metal dendrite is equal to or larger than an electric potential of the anode when metal ions separated from the cathode are not received yet in the anode.

In one preferred aspect, the secondary battery may be capable of sensing ripple that occurs when the metal ion receptor is electrically connected with the metal dendrite and an electric potential of the anode is changed. Alternatively, the secondary battery may be capable of indicating a defect thereof or stopping its operation, when a real-time absorption capacity of the metal ion receptor is equal to or greater than an expected deteriorated capacity of the secondary battery.

In a further preferred embodiment, when a real-time absorption capacity of the metal ion receptor and an expected deteriorated capacity of the battery cell having the metal ion receptor are compared and the real-time absorption capacity exceeds the expected deteriorated capacity by reference capacity or more, a BMS (Battery Management System) may alert a user to a problem with the battery cell or stop the battery cell from being used.

In an exemplary secondary battery, the metal dendrite may be formed by crystallization of metal ions separated from the cathode and received in the anode and the metal ions may include at least one of lithium ions, manganese ions, natrium ions, and zinc ions.

Preferably, the metal ion receptor may suitably have a reversible capacity of about 20 to 40% of a reversible capacity of the cathode. In addition, the metal ion receptor may include a porous material including carbon, graphite, tin, and silicon.

Further provided is a vehicle that includes the secondary battery as described herein.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional structure of an exemplary secondary battery according to an exemplary embodiment of the present invention;

FIG. 2 depicts an exemplary movement state of metal ions when a secondary battery according to an exemplary embodiment of the present invention is normally charged/discharged;

FIG. 3 depicts exemplary generation and absorption of an exemplary dendrite in an exemplary secondary battery according to an exemplary embodiment of the present invention;

FIG. 4 is a cross-sectional structure of an exemplary secondary battery according to an exemplary embodiment of the present invention and an exemplary movement state of metal ions when an exemplary secondary battery is normally charged/discharged; and

FIG. 5 is exemplary generation and absorption of an exemplary dendrite in an exemplary secondary battery according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, regions, integers, steps, operations, elements and/or components but do not preclude the presence or addition of one or more other features, regions, integers, steps, operations, elements, components, and/or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present invention will be described for those skilled in the art to easily achieve it.

As shown in FIG. 1, an exemplary secondary battery according to the present invention may include a cathode 14, an anode 12, and electrolytes 16, separators 18, and a metal ion receptor 20 for movement of metal ion between the cathode 14 and the anode 12 during charging/discharging.

The cathode 14 is an electrode that sends out metal ions in charging and stores metal ions in discharging. The metal ions may include, but not be limited to, at least one selected from lithium (Li), manganese (Mn), natrium (Na), and zinc (Zn) and a composite mixture including the selected any one can be used as a cathode active material. For instance, the metal ions separated from the cathode 14 and absorbed (or received) into the anode may include at least one selected from lithium, manganese, and zinc.

The cathode 14 may be manufactured by melting and mixing a cathode active material and a binder in a solvent and coating a metal base with the slurry mixed and produced in this way.

The anode 12 is an electrode that receives the metal ions from the cathode 14 in charging and may include at least one selected from graphite, carbon (C), tin (Sn), and silicon (Si) and a composite mixture including the selected any one may be used as an anode active material. A portion of the metal ions received in the anode 12 may return to the cathode 14 in discharging.

The anode 12 may be manufactured by melting and mixing an anode active material and a binder in a solvent and coating a metal base with the slurry mixed and produced in this way.

The electrolytes 16 allow metal ions to move in an ion state between the cathode 14 and the anode 12 and are disposed between the cathode 14 and the anode 12. Preferably, according to an exemplary embodiments, the metal ion receptor 20 and the separators 18, i.e. a first separator 18a and a second separator 18b, are disposed between the electrolytes.

The separators 18 (18a and 18b) may electrically separate the cathode 14 and the anode 12 to prevent direct contact between the electrodes when a battery cell 10 is charged/discharged, and prevent direct contact between the metal ion receptor 20 and the cathode 14 and direct contact between the metal ion receptor 20 and the anode 12. The separators 18 may be provided in pairs, i.e. the first and second separators 18a, 18b, such that the first separator may be disposed between the anode 12 and the metal ion receptor 20 on a first surface, which faces to the anode 12, and the second separator may be disposed between the cathode 14 and the metal ion receptor 20 on a second surface, which faces to the cathode 14. Further, the separators 18 may suitably comprise a porous insulator having fine pores (e.g., micropores, macropores or nanopores) through which only metal ions moving in the electrolytes 16 can pass through.

For instance, the separator may suitably include at least one selected from a plate-shaped porous insulator made of a polymer, non-woven fabric, and a solid electrolyte in the related arts. Preferably, a porous insulator having high thermal resistance may be used as the separator to secure safety of the battery. Further, the separators 18 may suitably have a thickness of about 6 to 30 μm for securing or improving energy density of the battery.

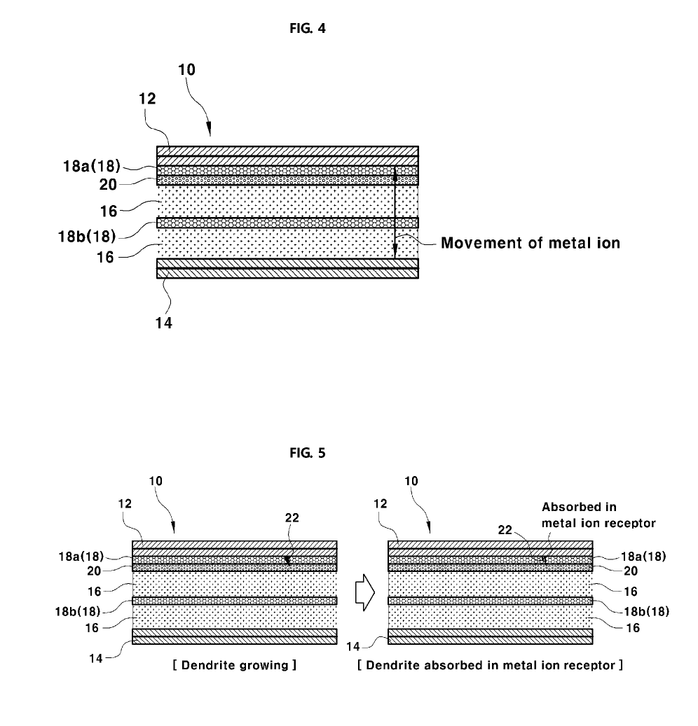

The metal ion receptor 20 may be electrically insulated by the separators 18 and disposed between the cathode 14 and the anode 12. In one exemplary embodiment, only one surface (i.e. first surface), which faces the anode 12, of the metal ion receptor 20 may be wrapped and insulated by the separator 18 (i.e. a first separator 18a), as shown in FIG. 4. In an exemplary embodiment, both surfaces of the metal ion receptor 20, i.e. the first surface facing to the anode 12 and a second surface facing to the cathode 14 of the metal ion receptor 20, may be wrapped and insulated by the first separator 18a and a second separator 18b, respectively, as shown in FIG. 1.

Preferably, the metal ion receptor 20 is insulated, at least, at the anode-sided first surface and packed by separator 18a, in which the separators 18a may be stacked and disposed in contact with the first surface of the metal ion receptor 20, thereby insulating the surface.

The first separator 18 disposed between the anode 12 and the metal ion receptor 20 is an anode-sided separator 18a, and the second separator 18 disposed between the cathode 14 and the metal ion receptor 20 is a cathode-sided separator 18b.

As shown in FIG. 1, when the first separator 18a is separated from the surface, which faces the metal ion receptor 20, of the anode 12 by the electrolyte 16 or a first electrolyte, the second separator 18b may be stacked on the second surface of the metal ion receptor 20 to insulate the second surface and to be separated from the surface of the cathode 14 by another electrolyte 16 or a second electrolyte.

As shown in FIG. 4, when the first separator 18a is in contact with the surface, which faces the metal ion receptor 20, of the anode 12 with the electrolyte 16 therebetween, the second separator 18b may be separated from the surface, which faces the metal ion receptor 20, of the cathode 14 by the second electrolyte 16 (lower) and may be spaced from the second surface of the metal ion receptor 20 with the first electrolyte 16 (upper).

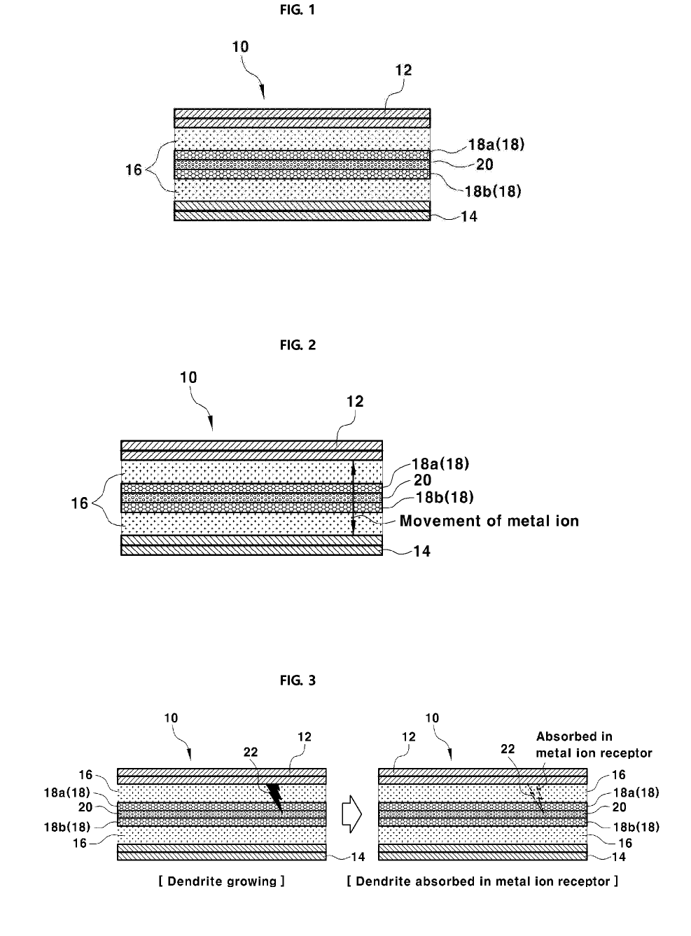

The metal ion receptor 20 may be insulated from the anode 12 and the cathode 14 and metal ions may pass or move between the cathode 14 and the anode 12 through the electrolytes 16 when the battery cell 10 is normally charged and discharged (see FIGS. 2 and 4). Preferably, the metal ion receptor 20 may perform the same function as the separators 18 when the battery cell 10 is charged and discharged.

Further, as shown in FIGS. 3 and 5, when a metal dendrite 22 grows in a needlelike shape on the surface, which faces the metal ion receptor 20, of the anode 12 due to charging of the battery cell 10 and penetrates the first separator 18a, the metal dendrite 22 may be in direct contact with the metal ion receptor 20 through the first separator 18a, and then, the anode 12 and the metal ion receptor 20 may be electrically connected through the metal dendrite 22. Accordingly, electrons can move from the anode 12 to the metal ion receptor 20 and the metal ions of the metal dendrite 22 may be moved and absorbed into the metal ion receptor 20 by the movement of the electrons. Accordingly, the metal dendrite 22 on the surface of the anode 12 may be gradually reduced and extinguished, but even if not completely extinguished, the metal dendrite 22 may be reduced at least until the electrical connection between the metal ion receptor 20 and the anode 12 disappears.

As growth of the dendrite 22 is suppressed, as described above, metal dendrite 22 may be prevented from growing and coming in direct contact with the cathode 14 through the metal ion receptor 20 and the second separator 18b. Accordingly, a short circuit in the battery cell 10 caused by direct contact between the anode 12 and the cathode 14 may be prevented.

In other words, when the battery cell 10 is charged, the metal dendrite 22 growing on the surface of the anode 12 may be electrically connected with the metal ion receptor 20 before the dendrite 22 reaches the surface of the cathode 14, in which the metallic substance of the metal dendrite 22 may be ionized and absorbed into the metal ion receptor 20 by movement of electrons between the metal ion receptor 20 and the anode 12. Indeed, the metal ion receptor 20 and the anode 12 may be instantaneously and temporarily connected to each other through the metal dendrite 22. Accordingly, a short circuit in the battery cell 10 caused by the metal dendrite 22 growing on the surface of the anode may be prevented and safety of the battery cell 10 may be improved.

The metal dendrite 22 may be produced from metal ions separated from the cathode 14 and received in the anode 12 when the battery cell 10 is charged. The metal ions may be crystallized and grow as crystalline on the surface of the anode 12, and the metal ions may include at least one selected as a cathode active material from lithium ions, manganese ions, natrium ions, and zinc ions.

Further, as the metal dendrite 22 may be reduced and extinguished, the electrical connection between the anode 12 and the metal ion receptor 20 through the metal dendrite 22 may be removed, but the separation (non-contact) and insulation between the anode 12 and the cathode 14 may be maintained by the cathode-sided separator 18b.

Since the metal ion receptor 20 is electrically connected with the anode 12 and the cathode 14 by the first separator 18a and the second separator 18b at both sides thereof, when the metal ion receptor 20 is electrically connected with the anode 12 by the metal dendrite 22, the potential of the anode 12 may be instantaneously changed, so the ripple of the battery cell 10 may occur.

Accordingly, an exemplary secondary battery may be capable of finding whether there is a problem with the battery cell 10 by sensing the ripple, so the battery can be more safely used.

The ripple may be generated by repetition of the electrical connection between the anode 12 and the metal ion receptor 20 through the metal dendrite 22 and absorption of the metal dendrite by the metal ion receptor 20, such that a volt gauge may be installed between the cathode 14 and the anode 12 outside the battery cell 10 to sense ripple of the battery cell 10.

In other words, an exemplary secondary battery may be capable of sensing whether there is a problem with the battery cell 10 in accordance with conditions set on the basis of ripple of the battery cell 10 which may occur when the metal ion receptor 20 is electrically connected with the metal dendrite 22 and the potential of the anode 12 is changed. For example, when the ripple is greater than a predetermined critical voltage, it can be determined that there is a problem with the battery cell 10.

The metal ion receptor 20 may include the same material as the material used as an anode active material or a composite mixture including the main component of an anode active material such that the metal ion receptor 20 may perform a similar function as the anode 12. In other words, the metal ion receptor 20 may absorb metal ions separated from the surface of the cathode 14 and receive on the surface of the anode 12.

Preferably, the material of the metal ion receptor 20 may include a porous material including a composite mixture including carbon, graphite, tin, and silicon that can absorb and receive metal ions separated from the cathode surface in charging. For example, the porous material including a metal oxide including a carbon-based material, a tin-based material, and a silicon-based material may be suitably used as the metal ion receptor 20.

The composite mixture of the porous material may suitably include a binder and the binder may be at least one of polyvinylidene difluoride (PVDF), polyacrylamide (PAA), polyacrylonitrile (PAN), styrene-butadiene rubber (SBR), and carboxymethylcellulose (CMC). Further, in order to maintain the pores of the porous material for the composite mixture, a binder of about 1 to 6 wt % and the remaining balance of about 94 99 wt % of the total weight of the composite mixture may be a carbon-based material, a tin-based material, and a silicon-based material.

Further, since it is possible to determine that a battery is in the normal use range until about 60 80% of the initial capacity is deteriorated, the metal ion receptor 20 may suitably have a reversible capacity of about 20 to 40% of the reversible capacity of the cathode 14.

The anode 12 may have reversible capacity of about 105 to 130% of the reversible capacity of the cathode 14 in consideration of the energy density of the battery cell 10 and the common inherent function of an anode.

Further, the metal ion receptor 20 may suitably have the value of potential (initial potential of the metal ion receptor) in a state when it does not receive metal ions from the metal dendrite 22 electrically connected with the metal ion receptor 20, equal to or greater than the value of potential (initial potential) of the anode 12 in a state when the metal ions separated from the cathode 14 are not received (before initial charging). This is because the metal ion receptor 20 may receive metal ions only when the metal ion receptor 20 is higher in potential than the anode 12.

The potential value of the metal ion receptor 20 and the potential value of the anode 12 may be potential values (electric potentials) measured on the basis of a standard point and the standard point may be oxidation reduction potential of the metallic material (lithium etc.) included in the cathode active material.

Further, the real-time absorption capacity of the metal ion receptor 20 absorbing and receiving metal ion of the metal dendrite 22 and an expected deteriorated capacity of the battery cell 10 having the metal ion receptor 20 may be compared so an alarm may be generated in accordance with the comparing result, there by letting a user know a problem with the battery cell or making the user stop using the battery.

The real-time absorption capacity refers to a metal ion capacity currently absorbed in the metal ion receptor 20 and the expected deteriorated capacity refers to a deteriorated capacity of the normal battery cell 10, that is, the currently deteriorated capacity of the battery cell 10 that is expected when the battery cell 10 is normal.

In detail, when the real-time absorption capacity of the metal ion receptor 20 is greater than the expected deteriorated capacity as much as reference capacity or greater, for example, when a condition that the real-time absorption capacity of the metal ion receptor 20 is greater than the expected deteriorated capacity of the battery cell 10 by about 5 to 10% is satisfied, an alarm may be generated or the battery stops being used.

To this end, a system for managing the battery may compare the real-time absorption capacity of the metal ion receptor 20 with the expected deteriorated capacity of the battery cell 10 and may generate an alarm enabling a user to recognize a problem with the battery cell 10 or stops the user using the battery cell 10 including the metal ion receptor 20.

For example, a BMS (Battery Management System) of a vehicle equipped with a secondary battery as a power source may be applied as the system.

The deteriorated capacity of the battery cell 10 refers to a difference between the initial capacity and the current capacity (real-time remaining capacity) of the battery cell 10.

As described above, according to the secondary battery of the present invention, since the metal ion receptor 20 disposed between the anode 12 and the cathode 14 may suppress growth of the metal dendrite 22 by absorbing the metal dendrite 22 that is generated on the surface of the anode 12 while the battery cell 10 is used, a short circuit due to direct contact between the anode 12 and the cathode 14 through the metal dendrite 22 may be efficiently prevented and whether the battery has a problem with the function on the basis of ripple that is generated due to electrical connection between the anode 12 and the metal ion receptor 20 through the metal dendrite 22 may be easily determined thereby minimizing problems with safety from using the battery cell.

That is, the secondary battery of the present invention may prevent a short circuit in the battery cell 10 by suppressing growth of the metal dendrite 22 that grows on the surface of the anode 12 by metal ions moving from the surface of the cathode 14 to the surface of the anode 12 when the battery cell 10 is charged, and a problem with the battery cell 10 may be easily detected by sensing ripple that is generated when the metal dendrite 22 is absorbed into the metal ion receptor 20.

According to the secondary battery of the present invention, when the battery cell is charged, the metal dendrite growing on the anode surface may be electrically connected with the metal ion receptor before the dendrite reaches the cathode surface, in which the dendrite is absorbed and received (inserted) in the metal ion receptor, so growth of the dendrite may be suppressed and a short due to the dendrite is prevented.

Further, according to the secondary battery, since the metal ion receptor is electrically connected with the anode and the cathode, when the metal ion receptor is electrically connected with the anode by a dendrite, the anode potential may be instantaneously changed, whereby ripple occurs. Accordingly, whether there is a problem with the battery may be determined and safer use of the battery may be provided by sensing the ripple.

Although embodiments of the present invention were described in detail above, the scope of the present invention is not limited thereto and various changes and modifications from the spirit of the present invention defined in the following claims by those skilled in the art are also included in the scope of the present invention.

What is claimed is:

1. A secondary battery comprising,
a cathode;
an anode;
electrolytes comprising a first electrolyte and a second electrolyte and disposed between the cathode and the anode;
separators comprising a first separator and a second separator and disposed between the cathode and the anode; and
a metal ion receptor disposed between the cathode and the anode, wherein at least a first surface, which faces the anode, of the metal ion receptor is contacted by the first separator.

2. The secondary battery of claim 1, wherein the first surface of the metal ion receptor is insulated by the first separator.

3. The secondary battery of claim 1, wherein, when the first electrolyte is disposed between a first surface of the first separator, which faces the anode, and a surface of the anode, the metal ion receptor is contacted by the second separator on a second surface that faces to the cathode.

4. The secondary battery of claim 3, wherein the second surface of the metal ion receptor is insulated by the second separator.

5. The secondary battery of claim 1, wherein, when the first separator is contacted by a surface of the anode, the second electrolyte is disposed between a second surface, which faces to the cathode, of the metal ion receptor and a first surface, which faces to the anode, of the second separator.

6. The secondary battery of claim 1, wherein, when a metal dendrite growing from the surface of the anode is electrically connected with the metal ion receptor through the first separator on the first surface of the metal ion receptor, the metal dendrite is received in the metal ion receptor.

7. The secondary battery of claim 6, wherein an electric potential of the metal ion receptor when the metal ion receptor does not receive the metal ions from the metal dendrite is equal to or greater than an electric potential of the anode when the metal ions separated from the cathode are not received in the anode.

8. The secondary battery of claim 6, wherein the secondary battery is capable of sensing ripple that occurs when the metal ion receptor is electrically connected with the metal dendrite and an electric potential of the anode is changed.

9. The secondary battery of claim 6, wherein the secondary battery is capable of indicating a defect thereof or stopping an operation, when a real-time absorption capacity of the metal ion receptor is equal to or greater than an expected deteriorated capacity of the secondary battery.

10. The secondary battery of claim 6, wherein the metal dendrite is formed by crystallization of metal ions separated from the cathode and received in the anode and the metal ions comprises at least one of lithium ions, manganese ions, natrium ions, and zinc ions.

11. The secondary battery of claim 6, wherein the metal ion receptor has a reversible capacity of about 20 to 40% of a reversible capacity of the cathode.

12. The secondary battery of claim 6, wherein the metal ion receptor comprises a porous material comprising carbon, graphite, tin, and silicon.

13. A vehicle comprising a secondary battery of claim 1.
